(19) United States
(12) Patent Application Publication
(10) Pub. No.: US 2026/0018892 A1
(43) Pub. Date: Jan. 15, 2026

(54) SYSTEM AND METHOD FOR AUTO-CONFIGURING A POWER DISTRIBUTION SYSTEM ARCHITECTURE

(71) Applicant: Hamilton Sundstrand Corporation, Charlotte, NC (US)

(72) Inventors: Alex Gomes, Chicago, IL (US); Alex Pereira, Bronx, NY (US); Michael J. Scully, Rockford, IL (US)

(21) Appl. No.: 18/772,966

(22) Filed: Jul. 15, 2024

(51) Int. Cl. H02J 3/12; G05F 1/66

(52) U.S. Cl. CPC H02J 3/12; G05F 1/66; H02J 2310/44

(57) ABSTRACT

A system includes multiple solid state power controller (SSPC) modules arranged in a distribution system architecture. The system also includes a distribution system controller communicatively coupled to the multiple SSPC modules. The distribution system controller is configured to detect a new or changed SSPC module among the multiple SSPC modules, send identification or configuration information about the new or changed SSPC module to a maintenance computer or a cockpit display, receive at least one input regarding a configuration for the new or changed SSPC module, store the configuration of the new or changed SSPC module in a non-volatile memory of the distribution system controller, and control the new or changed SSPC module according to the stored configuration.

### TECHNICAL FIELD

This disclosure is generally directed to electrical power distribution systems. More specifically, this disclosure is directed to a system and method for auto-configuring a power distribution system architecture.

### BACKGROUND

In typical electrical power distribution systems, such as those found on many aircraft, multiple solid state power controller (SSPC) modules are arranged together in a distribution system architecture, and are controlled by a distribution system controller. Each SSPC is a semiconductor device that controls power (i.e., voltage and/or current) supplied to a load, providing wiring protection similar to a traditional electric circuit breaker in an electrical power distribution system, but with additional logic and capabilities not found in traditional electric circuit breakers.

### SUMMARY

This disclosure is directed to system and method for auto-configuring a power distribution system architecture.

In some embodiments, a system includes multiple solid state power controller (SSPC) modules arranged in a distribution system architecture. The system also includes a distribution system controller communicatively coupled to the multiple SSPC modules. The distribution system controller is configured to detect a new or changed SSPC module among the multiple SSPC modules, send identification or configuration information about the new or changed SSPC module to a maintenance computer or a cockpit display, receive at least one input regarding a configuration for the new or changed SSPC module, store the configuration of the new or changed SSPC module in a non-volatile memory of the distribution system controller, and control the new or changed SSPC module according to the stored configuration.

In other embodiments, a control device includes at least one processing device configured to detect a new or changed SSPC module among multiple SSPC modules arranged in a distribution system architecture, the multiple SSPC modules communicatively coupled to the control device, send identification or configuration information about the new or changed SSPC module to a maintenance computer or a cockpit display, receive at least one input regarding a configuration for the new or changed SSPC module, store the configuration of the new or changed SSPC module in a non-volatile memory of the control device, and control the new or changed SSPC module according to the stored configuration.

In still other embodiments, a method includes detecting a new or changed SSPC module among multiple SSPC modules arranged in a distribution system architecture, the multiple SSPC modules communicatively coupled to a distribution system controller. The method also includes sending identification or configuration information about the new or changed SSPC module to a maintenance computer or a cockpit display. The method also includes receiving at least one input regarding a configuration for the new or changed SSPC module. The method also includes storing the configuration of the new or changed SSPC module in a non-volatile memory of the distribution system controller. The method also includes controlling the new or changed SSPC module according to the stored configuration.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example system for auto-configuring a power distribution system architecture according to this disclosure;

FIG. 2 illustrates an example device for use in a system for auto-configuring a power distribution system architecture, according to this disclosure; and

FIG. 3 illustrates an example method for auto-configuring a power distribution system architecture according to this disclosure.

### DETAILED DESCRIPTION

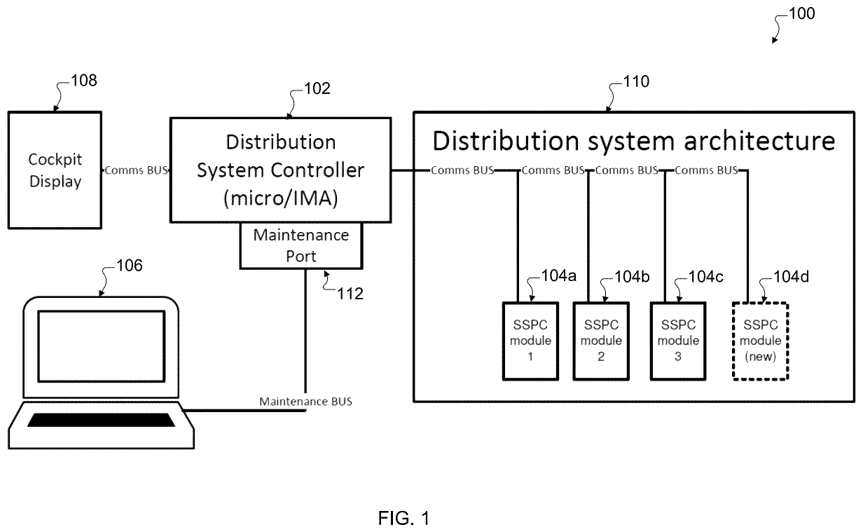

FIGS. 1 through 3, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

For simplicity and clarity, some features and components are not explicitly shown in every figure, including those illustrated in connection with other figures. It will be understood that all features illustrated in the figures may be employed in any of the embodiments described. Omission of a feature or component from a particular figure is for purposes of simplicity and clarity and is not meant to imply that the feature or component cannot be employed in the embodiments described in connection with that figure. It will be understood that embodiments of this disclosure may include any one, more than one, or all of the features described here. Also, embodiments of this disclosure may additionally or alternatively include other features not listed here.

As discussed above, in typical electrical power distribution systems, such as those found on many aircraft, multiple solid state power controller (SSPC) modules are arranged together in a distribution system architecture, and are controlled by a distribution system controller. Each SSPC module is a semiconductor-based card that controls power (i.e., voltage and/or current) supplied to a load, similar to a traditional electric circuit breaker in an electrical power distribution system, but with additional logic and capabilities not found in traditional electric circuit breakers. When there is a need to update the configuration to add or change SSPC modules (for example, to allow more or different components to be powered), there are currently limited options for configuration. Typical options include re-evaluating the whole communications bus architecture, modifying and reloading completely updated software for the distribution system controller, or loading a new configuration file to allow each new SSPC module to initialize and then be controlled by the distribution system controller. Without at least one of these steps, either the system will ignore the newly added SSPC card and configuration change, or it will send a configuration error message to the flight crew after the system is initialized.

This disclosure provides systems and methods for auto-configuring a power distribution system architecture. The disclosed embodiments can be used with an aviation vehicle or aircraft. As discussed in greater detail below, the disclosed embodiments allow the aircraft operator or owner to easily configure, control, and operate distribution system updates without the need for using complex computer applications to generate new distribution system controller software or PDI (parameter data item) files. The disclosed embodiments allow simple system configuration pre-sets to be used and generate a new configuration file that can be stored into the distribution system controller's internal memory. The disclosed system enables the aircraft operator or owner to download the data for capturing their aircraft updated configuration and apply it to any other aircraft with the same distribution system architecture. Note that while this disclosure is described with respect to aircraft, it will be understood that the principles disclosed here are also applicable to other types of devices or environments.

FIG. 1 illustrates an example system 100 for auto-configuring a power distribution system architecture according to this disclosure. As shown in FIG. 1, the system 100 includes a distribution system controller 102, multiple SSPC modules 104a-104d, a maintenance computer 106, and a cockpit display 108. In some embodiments, the system 100 can be installed in, or otherwise used with, a flight vehicle or aircraft.

The distribution system controller 102 comprises one or more computing devices that operate to control various operations of the power distribution system. As described in greater detail below, the distribution system controller 102 is configured to detect new and changed SSPC modules 104a-104d, and provide configuration and control for the SSPC modules 104a-104d once the SSPC modules 104a-104d are detected. For example, when the aircraft is initialized in maintenance mode, the distribution system controller 102 can actively search for changes in configuration of the SSPC modules 104a-104d, such as the presence of a new SSPC module 104a-104d. The distribution system controller 102 hosts software, firmware, or a combination of the two, that provide interaction with maintenance personnel and enable configuration of the SSPC modules 104a-104d.

As known in the art, each SSPC module 104a-104d is comprised of various solid state switches, transistors, or the like, and operates as (or similar to) a traditional electronic circuit breaker. Each SSPC module 104a-104d provides power and power control to one or more electrical or electronic devices downstream of that SSPC module 104a-104d. The SSPC modules 104a-104d are communicatively coupled to the distribution system controller 102 via a communication bus and are arranged together as part of a distribution system architecture 110. In the system 100, each SSPC module 104a-104d holds its identification and configuration in its own non-volatile memory (NVM).

Because each SSPC module 104a-104d is electronic, it is programmable or configurable with data, parameters, and the like, that affect how the SSPC module 104a-104d operates. These parameters can include the names and types of the downstream equipment that is being protected, circuit trip rating(s) of the SSPC module 104a-104d (such as in amps), initial and default states, module location identifier, authentication information, control logic that controls the downstream equipment based on the circumstances and environmental conditions in which the SSPC module 104a-104d operates (such as flying at a particular altitude, outside temperature is below a threshold, etc.), and the like.

The maintenance computer 106 is a computing device configured to read and display any new installations of the SSPC modules 104a-104d and changes in the overall system. In some embodiments, the maintenance computer 106 is an integral part of the aircraft, such as a computing device installed into the cockpit. In other embodiments, the maintenance computer 106 is a separate device, such as a laptop, that can be connected to a wired or wireless maintenance port 112 of the distribution system controller 102. The maintenance computer 106 can interact with maintenance personnel, such as by displaying messages and receiving inputs from the maintenance personnel. The maintenance computer 106 can also communicate with the distribution system controller 102 (such as via a maintenance bus) to exchange information related to configuration of any new installations of the SSPC modules 104a-104d and changes in the overall system.

The cockpit display 108 represents one or more displays or user interfaces disposed within the cockpit of the aircraft. The cockpit display 108 can be used as an alternative to the maintenance computer 106 or as an additional user interface for performing configuration and maintenance of the system 100.

In one aspect of operation, maintenance personnel can install a new SSPC module 104a-104d (such as the SSPC module 104d shown in FIG. 1) in the aircraft. In some embodiments, the new SSPC module 104d may be installed to support new electrical or electronic equipment (e.g., new food service equipment or the like) that is also being installed in the aircraft.

Once the new SSPC module 104d is installed and powered up, the new SSPC module 104d initializes all its SSPCs or switches in a disabled/OPEN state, and the distribution system controller 102 detects the presence of the new SSPC module 104d. For example, the new SSPC module 104d can announce its presence to the distribution system controller 102 via the communications bus. The distribution system controller 102 then sends identification and/or current configuration information about the new SSPC module 104d to the maintenance computer 106 (or a maintenance page in the cockpit display 108). This information prompts the maintenance computer 106 to display a message to the maintenance personnel. For example, the maintenance computer 106 can display a message instructing the maintenance personnel to authenticate their session.

Once the maintenance personnel's access to the system reconfiguration pages has been authenticated, then the distribution system controller 102 provides one or more options associated with configuration of the new SSPC module 104d. The distribution system controller 102 can provide the options to the maintenance personnel by instructing the maintenance computer 106 to display one or more messages to the maintenance personnel. For example, the maintenance computer 106 may display the following message to the maintenance personnel: “A new SSPC card is identified. What do you want to do with the new card? Here are a few options for configuring the new card.” The message can be displayed with a list of options for the new SSPC module 104d, from which the maintenance personnel can select one or more of the options. These options can include any one or more of the following:
1. Assign the new SSPC module 104d to an OFF state.
2. Assign the new SSPC module 104d to an always ON state.
3. Assign the naming and ratings for the new SSPC module 104d.
4. Generate a new PDI file from the manually assigned configuration according to items 1, 2, and/or 3 above.
5. Load a new PDI file into a non-volatile memory of the distribution system controller 102; the new PDI file can control the new SSPC module 104d and set its configuration (name, ratings, and the like).
6. Download the newly created PDI file (from step 4) to store it outside the aircraft for future usage.

Based on any options selected by the maintenance personnel, the distribution system controller 102 adopts a particular configuration for the new SSPC module 104d. In some embodiments, the distribution system controller 102 stores information (parameters, data, and the like) associated with the particular configuration in an internal non-volatile memory. The distribution system controller 102 is then able to access the configuration information for controlling the new SSPC module 104d during the system 100's run-time operation (such as during taxiing, take-off, flight, etc.).

As described above, the system 100 enables automatic detection, automatic request for personnel instructions, and automatic configuration of SSPC modules 104a-104d. This is an advantageous benefit over conventional systems that require maintenance personnel to load preconfigured software and/or PDI (from a remote/outside computer platform), in order to allow the system to operate properly with the new or modified SSPC card.

Although FIG. 1 illustrates an example system for auto-configuring a power distribution system architecture and related details, various changes may be made to FIG. 1. For example, while FIG. 1 shows four SSPC modules 104a-104d, actual implementations can include other numbers of SSPC modules 104a-104d. In addition, various components shown and described above may be combined, further subdivided, replicated, rearranged, or omitted and additional components may be added according to particular needs.

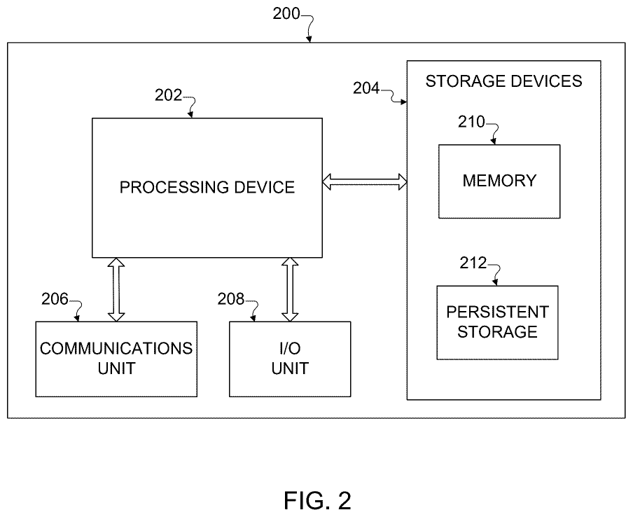

FIG. 2 illustrates an example device 200 for use in a system for auto-configuring a power distribution system architecture, according to this disclosure. One or more instances of the device 200 may, for example, be used to at least partially implement the functionality of the distribution system controller 102, the maintenance computer 106, and/or the cockpit display 108 of FIG. 1. However, the functionality of the distribution system controller 102, the maintenance computer 106, and/or the cockpit display 108 may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 can be accessed remotely.

In some embodiments, the instructions executed by the processing device 202 can include instructions that implement the functionality of the distribution system controller 102, the maintenance computer 106, and/or the cockpit display 108 described above. For example, the instructions executed by the processing device 202 can include instructions for controlling or configuring one or more of the SSPC modules 104a-104d.

Although FIG. 2 illustrates one example of a device 200 for use in a system for auto-configuring a power distribution system architecture, various changes may be made to FIG. 2. For example, computing devices and systems come in a wide variety of configurations, and FIG. 2 does not limit this disclosure to any particular computing device or system.

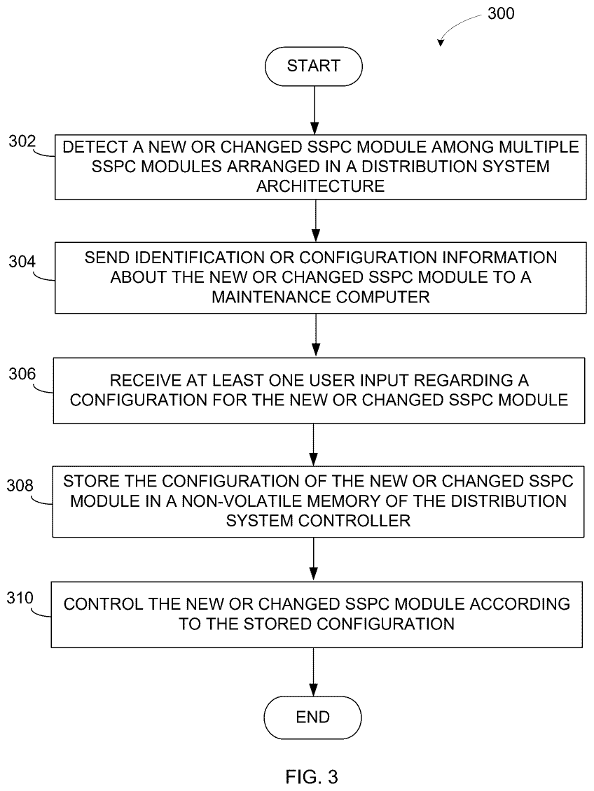

FIG. 3 illustrates an example method 300 for auto-configuring a power distribution system architecture according to this disclosure. For case of explanation, the method 300 is described as being performed using the system 100 of FIG. 1. However, the method 300 could be used with any other suitable device or system.

As shown in FIG. 3, at step 302, a new or changed SSPC module is detected among multiple SSPC modules arranged in a distribution system architecture, the multiple SSPC modules communicatively coupled to a distribution system controller. This may include, for example, the distribution system controller 102 detecting the new SSPC module 104d among the SSPC modules 104a-104d.

At step 304, identification or configuration information about the new or changed SSPC module is sent to a maintenance computer or cockpit display. This may include, for example, the distribution system controller 102 sending identification or configuration information about the new SSPC module 104d to the maintenance computer 106 or the cockpit display 108.

At step 306, at least one user input regarding a configuration for the new or changed SSPC module is received. This may include, for example, the distribution system controller 102 receiving at least one user input regarding a configuration for the new SSPC module 104d.

It is noted that during steps 302-306, the new or changed SSPC module has its own SSPCs all disabled/OPEN, which means that the SSPCs are not providing power on their respective outputs.

At step 308, the configuration of the new or changed SSPC module is stored in a non-volatile memory of the distribution system controller. This may include, for example, the distribution system controller 102 storing the configuration of the new SSPC module 104d in a non-volatile memory of the distribution system controller 102. Once the configuration is stored, one of the following can occur before the new or changed SSPC module starts to fully operate:
1. A clear message is provided to the maintenance personnel asking if they want the new or changed SSPC module to start operating (i.e., providing power) at this moment.
2. A system reboot (i.e., power down, then power up), which causes the distribution system controller 102 to use the newly configured data to operate/control the new or changed SSPC module.

At step 310, the new or changed SSPC module is controlled according to the stored configuration. This may include, for example, the distribution system controller 102 controlling the new SSPC module 104d according to the stored configuration.

Although FIG. 3 illustrates one example of a method 300 for auto-configuring a power distribution system architecture, various changes may be made to FIG. 3. For example, while shown as a series of steps, various steps shown in FIG. 3 could overlap, occur in parallel, occur in a different order, or occur multiple times. Moreover, some steps could be combined or removed and additional steps could be added according to particular needs.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
multiple solid state power controller (SSPC) modules arranged in a distribution system architecture; and
a distribution system controller communicatively coupled to the multiple SSPC modules, the distribution system controller configured to:
detect a new or changed SSPC module among the multiple SSPC modules;
send identification or configuration information about the new or changed SSPC module to a maintenance computer or a cockpit display;
receive at least one input regarding a configuration for the new or changed SSPC module;
store the configuration of the new or changed SSPC module in a non-volatile memory of the distribution system controller; and
control the new or changed SSPC module according to the stored configuration.

2. The system of claim 1, wherein the at least one input comprises a user selection of one or more options from a list of candidate configuration options, the candidate configuration options comprising two or more of:
assign the new or changed SSPC module to an OFF state;
assign the new or changed SSPC module to an always ON state;
assign a naming and ratings for the new or changed SSPC module;
generate a new parameter data item (PDI) file for the new or changed SSPC module;
load a new PDI file into the non-volatile memory of the distribution system controller; or
download a new PDI file to store externally for future usage.

3. The system of claim 1, wherein:
the maintenance computer is communicatively coupled to the distribution system controller; and
the maintenance computer is configured to receive the at least one input regarding the configuration for the new or changed SSPC module from a maintenance personnel.

4. The system of claim 3, wherein the maintenance computer is connected to a maintenance port of the distribution system controller.

5. The system of claim 1, wherein the configuration of the new or changed SSPC module comprises at least one of: one or more names and types of downstream equipment that is being protected, one or more circuit trip ratings of the new or changed SSPC module, initial and default states of the new or changed SSPC module, a module location identifier, authentication information, or control logic that controls the downstream equipment based on one or more circumstances and environmental conditions in which the new or changed SSPC module operates.

6. The system of claim 1, wherein the SSPC modules and the distribution system controller are installed in an aircraft.

7. The system of claim 6, wherein the aircraft is initialized in maintenance mode.

8. A control device comprising:
at least one processing device configured to:
detect a new or changed solid state power controller (SSPC) module among multiple SSPC modules arranged in a distribution system architecture, the multiple SSPC modules communicatively coupled to the control device;
send identification or configuration information about the new or changed SSPC module to a maintenance computer or a cockpit display;
receive at least one input regarding a configuration for the new or changed SSPC module;
store the configuration of the new or changed SSPC module in a non-volatile memory of the control device; and
control the new or changed SSPC module according to the stored configuration.

9. The control device of claim 8, wherein the at least one input comprises a user selection of one or more options from a list of candidate configuration options, the candidate configuration options comprising two or more of:
assign the new or changed SSPC module to an OFF state;
assign the new or changed SSPC module to an always ON state;
assign a naming and ratings for the new or changed SSPC module;
generate a new parameter data item (PDI) file for the new or changed SSPC module;
load a new PDI file into the non-volatile memory of the control device; or download a new PDI file to store externally for future usage.

10. The control device of claim 8, wherein:
the maintenance computer is communicatively coupled to the control device; and
the maintenance computer is configured to receive the at least one input regarding the configuration for the new or changed SSPC module from a maintenance personnel.

11. The control device of claim 10, wherein the maintenance computer is connected to a maintenance port of the control device.

12. The control device of claim 8, wherein the configuration of the new or changed SSPC module comprises at least one of: one or more names and types of downstream equipment that is being protected, one or more circuit trip ratings of the new or changed SSPC module, initial and default states of the new or changed SSPC module, a module location identifier, authentication information, or control logic that controls the downstream equipment based on one or more circumstances and environmental conditions in which the new or changed SSPC module operates.

13. The control device of claim 8, wherein the SSPC modules and the control device are installed in an aircraft.

14. The control device of claim 13, wherein the aircraft is initialized in maintenance mode.

15. A method comprising:
detecting a new or changed solid state power controller (SSPC) module among multiple SSPC modules arranged in a distribution system architecture, the multiple SSPC modules communicatively coupled to a distribution system controller;
sending identification or configuration information about the new or changed SSPC module to a maintenance computer or a cockpit display;
receiving at least one input regarding a configuration for the new or changed SSPC module;
storing the configuration of the new or changed SSPC module in a non-volatile memory of the distribution system controller; and
controlling the new or changed SSPC module according to the stored configuration.

16. The method of claim 15, wherein the at least one input comprises a user selection of one or more options from a list of candidate configuration options, the candidate configuration options comprising two or more of:
assign the new or changed SSPC module to an OFF state;
assign the new or changed SSPC module to an always ON state;
assign a naming and ratings for the new or changed SSPC module;
generate a new parameter data item (PDI) file for the new or changed SSPC module;
load a new PDI file into the non-volatile memory of the distribution system controller; or
download a new PDI file to store externally for future usage.

17. The method of claim 15, wherein:
the maintenance computer is communicatively coupled to the distribution system controller; and
the maintenance computer is configured to receive the at least one input regarding the configuration for the new or changed SSPC module from a maintenance personnel.

18. The method of claim 17, wherein the maintenance computer is connected to a maintenance port of the distribution system controller.

19. The method of claim 15, wherein the configuration of the new or changed SSPC module comprises at least one of: one or more names and types of downstream equipment that is being protected, one or more circuit trip ratings of the new or changed SSPC module, initial and default states of the new or changed SSPC module, a module location identifier, authentication information, or control logic that controls the downstream equipment based on one or more circumstances and environmental conditions in which the new or changed SSPC module operates.

20. The method of claim 15, wherein the SSPC modules and the distribution system controller are installed in an aircraft.
